(19) United States
(12) Patent Application Publication
(10) Pub. No.: US 2022/0034803 A1
(43) Pub. Date: Feb. 3, 2022

(54) OPTICAL MULTIMETER

(71) Applicant: Jan KÅHRE, Helsingfors (FI)

(72) Inventor: Jan KÅHRE, Helsingfors (FI)

(21) Appl. No.: 17/390,380

(22) Filed: Jul. 30, 2021

(30) Foreign Application Priority Data
Jul. 31, 2020 (FI) 20205777
Nov. 30, 2020 (FI) 20206219

(51) Int. Cl. G01N 21/41; G01N 21/31; G01N 21/49; G01N 21/64

(52) U.S. Cl. CPC G01N 21/4133; G01N 21/31; G01N 2021/6463; G01N 21/645; G01N 21/49

(57) ABSTRACT

The present disclosure embodies an improved optical instrument that includes an embodied fitting to the standardized probe with the optical structure to facilitate refractometer optics to the probe tip with a turbidity and/or color meter to form an embodied optical multimeter.

### CROSS-REFERENCE TO RELATED APPLICATIONS

This application claims priority to Finnish Application No. 20205777 filed Jul. 31, 2020 and Finnish Application No. 20206219 filed Nov. 30, 2020, the entire contents of each of which are hereby incorporated by reference.

### BACKGROUND OF THE INVENTION

### Field of the Invention

In general, the disclosure of the presently embodied invention relates to the field of optics, but in more specifically to improvements in optical structure for optical measurements used to be made by process refractometers, and even in more specifically to measurements of turbidity by an improved refractometer structure.

### Description of the Related Art

For optical in-line measurement of process liquid properties, there are two principal modes:

1. Measuring on the surface of the liquid and

2. Measuring in the bulk of the liquid.

A process refractometer measures optically the refractive index of a process liquid in line, at the interface of the refractometer and the process liquid in a surface measurement: The refractometer measures on a thin film of liquid wetting a prism surface.

A prism surface in refractometers forms the interface between the optics and the process liquid. With reference to FIG. 1, in general about the operating principle of a refractometer, the refractometer determines the refractive index RI of the process liquid by measurement of the critical angle of total reflection. Light from the light source (LED) in FIG. 1 is directed to the interface via an optical arrangement comprising a collimator and condenser lenses between the light source and the incident side of the prism surface acting as an incident mirror, from which the light propagates to the interface of the prism and the process liquid as a medium, and from there to the secondary side of the prism surface acting as a secondary mirror from which the light continues to the optics with objective lens and image sensor, with the provision that the light to the interfacing surface comes to the critical angle or a higher angle in respect to the normal of the surface, but otherwise is penetrating into the medium through the interfacing surface. The two prism surfaces acting as mirrors are bending the light rays so that they meet the interface at different angles.

In FIG. 1 there is illustrated also optical images as a refractometer sees the image on the image sensor. The refractive index RI can then be determined from the position of the edge at the dark zone and the light zone. The dark zone and the light zone are formed because of the total reflection according to the Snell's law on total reflection at the interface of the process liquid and the prism contacting the process liquid.

As the refractive index RI changes with the process solution concentration, refractometer can be used in the concentration measurement of the process liquid as based on the mentioned dependence. Normally the refractive index RI increases when the concentration increases. From the follows that the concentration of the process liquid can be read from the optical image from the position of the edge of the dark and light zones.

The critical angle evanescent rays do not penetrate far into the process liquid. The penetration depth by an evanescent wave is of the order of the wavelength of the light source. The critical angle of total reflection has been shown. Hence, the liquid sample to be measured is a thin film of process liquid on the prism surface.

As an example of a bulk measurement, a conventional turbidity measurement is illustrated in FIGS. 2 and 3, by illuminating the particles in the process through a window and measuring the reflected light (FIG. 2) by a photo receptor. The amount of returned light is a measure of turbidity. A turbidity measurement is schematically disclosed as such also via the FIG. 3, illustrating a turbidity measurement by using a mirror so that the emitted light reflected from: suspended particles or from a mirror submerged in the liquid has been used to indicate the turbidity in a turbidity measurement as such as disclosed via FIG. 3.

Another bulk type measurement is the color measurement of the process liquid. Color is measured by directing a light ray through a window on a mirror submerged in the process liquid and measuring the reflected ray by a photo receptor. The amount of returned light is a measure of the light absorption in the sample volume (FIG. 3), or color. The same measurement can be achieved by an external light source replacing the mirror.

### SUMMARY OF THE INVENTION

According to the disclosure of the embodiments of the invention concerning an improved optical instrument, i.e. optical multimeter, a refractometer as such and any of the optical bulk measurements for turbidity and/or color as such can be combined together into such an improved optical instrument. The respective measurement methods are known as such, but now the user gets all the referred optical properties of the process liquid by installing only one embodied instrument to the measurement location.

When an optical bulk measurement is integrated in a refractometer, the refractometer has already provided for the pipe work engineering, the process connection, the measurement window, the probe, and a built-in microprocessor communicating with the factory control system. To add an optical bulk meter instrument, there is only a need to add a couple of cheap mass-produced electronic components and some program lines to the microprocessor. Compared to procuring freestanding optical bulk instrument, the addition to a refractometer according to this embodiment is practically at zero cost.

Moreover, in this embodiment, the refractive index measurement can be used to correct the bulk measurements, which isn't possible if measured by separate instruments.

This is possible by using an improved structure, where the refractometer prism is used as the bulk measurement window. Accordingly, the “smallest angle” as indicated in the embodiments, corresponds to the lowest concentration the refractometer can measure, typically water. If the process liquid is water, then all rays with an angle of incidence greater than the “smallest angle” is reflected. This means that all rays with angle of incidence less than the “smallest angle” penetrates water and are eligible for the bulk measurements.

Both of the refractometer and the optical bulk measurements here described are well established devices being used in measurement methods. What's new and innovative, is to combine them in the same device, where the refractometer prism does double duty as a bulk measurement window.

According to an embodiment variant, optionally to direct light from the light sources, also optical fibers can be used to transfer the light. Especially for small diameter probes, this is useful to save space. by the optical fiber for the light path.

It is important to notice that the bulk properties of the process liquid doesn't disturb the refractometer's measurement of the process liquid concentration. That is used as a commercial benefit for a selling point for a refractometer, i.e. Insensitiveness to particles, bubbles and color of the liquid. The refractometer measures the edge of the light zone on the image sensor (FIG. 1) as such. The light zone consists of the totally reflected rays. The reflected rays do not penetrate the process liquid; hence they are oblivious of the volume properties.

The other way around is not true, as the refractive index of the process liquid influences the bulk measurements. What happens at the surface influences the bulk measurements. As rays pass from the prism to the process liquid, the transmission intensities and the directions can be influenced by the refractive indices of the prism and the liquid respectively. That influence is determined by Fresnel's equations as such. As the refractive index of the liquid varies, there may be a need to compensate the optical bulk measurement for this variation. The embodiments of the present disclosure of the invention has the unique capability to perform this compensation.

The measurement of process temperature can also be added to the embodied optical multimeter, as a refractometer probe already contains a temperature measurement element for its temperature compensation, provided that the probe diameter makes it accepted as a thermowell for industrial temperature measurement. Typically, this diameter is ½″ or 12 mm.

Yet, there is another aspect of the embodied improved optical instrument related to the probe diameter. In the pharmaceutics industry, a probe diameter of 12 mm is a standard for measurement of pH. An improved optical instrument with a 12 mm probe would be advantageous, because it can be installed in standard certified pharmaceutical fittings, which is another surprising effect of the embodiments of the invention.

An improved optical instrument according to an embodiment of the present disclosure comprises at least one of the following within a same refractometer probe: A turbidity meter and a color meter.

The improved optical instrument according to an embodiment of the present disclosure comprises in the same device, the refractometer prism in a double duty as a refractometer prism and a bulk measurement window.

The improved optical instrument according to an embodiment of the present disclosure comprises such a color meter that is adapted in the color measurement to apply in turn more than one light sources of different wavelengths.

The improved optical instrument according to an embodiment of the present disclosure comprises an ensemble of sources to each color that are detected by a receptor, to transform the optical signal in each respective color to corresponding electrical signal to provide a combination of the color signals in the measurements to yield the true color of the process liquid. According to an embodiment a suitable light detector as such can be used as a receptor. According to an embodiment, linear array image detector can be used as a suitable receptor, for example with refractometer.

The improved optical instrument according to an embodiment of the present disclosure comprises at least one light source of the light sources whose emitted light has a wavelength that is in the optical spectrum range, i.e. 400 nm to 700 nm

The improved optical instrument according to an embodiment of the present disclosure comprises at least one of the light sources of the optical instrument that has such a light source whose emitted light has a wavelength that is outside the said visible spectrum range, i.e. up to a wavelength that is below 10 μm, advantageously below 6 μm, and even more advantageously below 5 μm, but simultaneously above 0.2 μm.

Use according to an embodiment of the present disclosure comprises use of the improved optical instrument according to an embodiment of the present disclosure in measuring absorption peaks.

Use according to an embodiment of the present disclosure comprises use of the improved optical instrument according to measure absorption peaks comprising absorption peak of carbon dioxide CO2.

The improved optical instrument according to an embodiment of the present disclosure comprises a light source to provide incident light in a fluorescence measurement of the process liquid.

The improved optical instrument according to an embodiment of the present disclosure comprises a receptor acting as a detector to detect as a secondary fluorescence light, at a fluorescence light source wavelength stimulated light as a response to the incident light.

The improved optical instrument according to an embodiment of the present disclosure comprises an optical filter to filter out such light with wavelengths that are outside a certain desired range of fluorescence measurement light wavelengths, in a wavelength range that is of said incident light and/or secondary light.

The improved optical instrument according to an embodiment of the present disclosure comprises an ensemble of light sources each with at least one light-source-dedicated wavelength to emit the light in a bulk measurement by the improved optical instrument.

The improved optical instrument according to an embodiment of the present disclosure comprises such an ensemble of light sources that are set to lighten in a sequence controlled by a controller to control the light source illumination in a bulk measurement by the improved bulk measurement.

The improved optical instrument according to an embodiment of the present disclosure comprises a probe tip diameter of ½″ or 12 mm.

A optical instrument system according to an embodiment of the present disclosure comprises at least one improved optical instrument according to an embodiment of the present disclosure comprises, wherein the system comprises further a microprocessor, to control the illumination of at least one light source in a bulk measurement, as to provide the functionality of the controller of the optical instrument system. In such system the microprocessor can be embodied by an internal microprocessor of the improved optical instrument, and/or an external microprocessor, such as in a computer connected to the improved optical instrument.

A software code on a non-transitory computer readable media, comprising a computer executable code when run in a microprocessor to provide controller to control the optical instrument system according to an embodiment of the present disclosure.

The software code according to an embodiment of the present disclosure comprises instructions to microprocessor to control in a consecutive manner to turn the light on and off of the light sources of the improved optical instrument according to an embodiment of the present disclosure

The expression “a number of” refers herein to any positive integer starting from one (1), e.g. to one, two, or three.

The expression “a plurality of” refers herein to any positive integer starting from two (2), e.g. to two, three, or four.

Different examples on embodiments of the present disclosure of embodiments of the invention are disclosed and claimed.

Any discussion of documents, acts, materials, devices, articles or the like which has been included in the present specification is not to be taken as an admission that any or all of these matters form part of the prior art base or were common general knowledge in the field.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF THE DRAWINGS

FIGS. 1 to 3 illustrate background techniques as such and the optical aspects thereof as such.

In the following, embodiments of the present invention are disclosed by non-limiting examples with reference to the FIGS. 4 to 5b, in which

FIG. 4 illustrates an example of a prism of an embodied improved optical instrument optics, to be in combination to one or more embodiments,

FIG. 5a illustrates a ray path example in an embodied improved optical instrument probe, to be in combination to one or more embodiments, and

FIG. 5b illustrates an optional ray routing to FIG. 5a path example, to be in combination to one or more embodiments,

### DESCRIPTION OF THE PREFERRED EMBODIMENTS

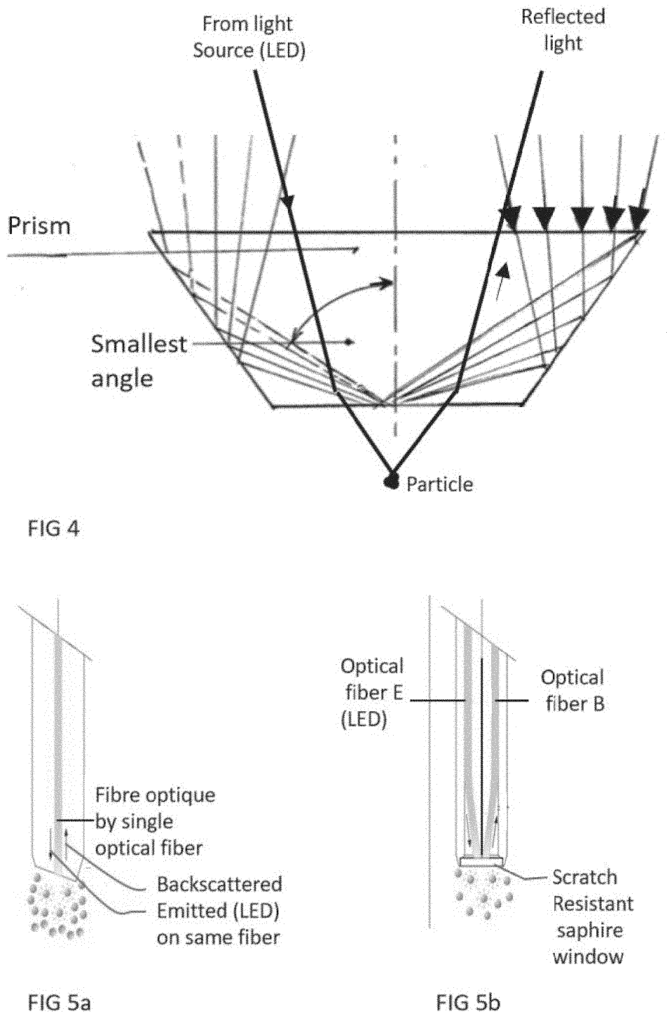

According to an embodiment of the present disclosure, the design goal has been made by the prism of an improved optical instrument that can utilize a refractometer optics as exemplified in FIG. 4.

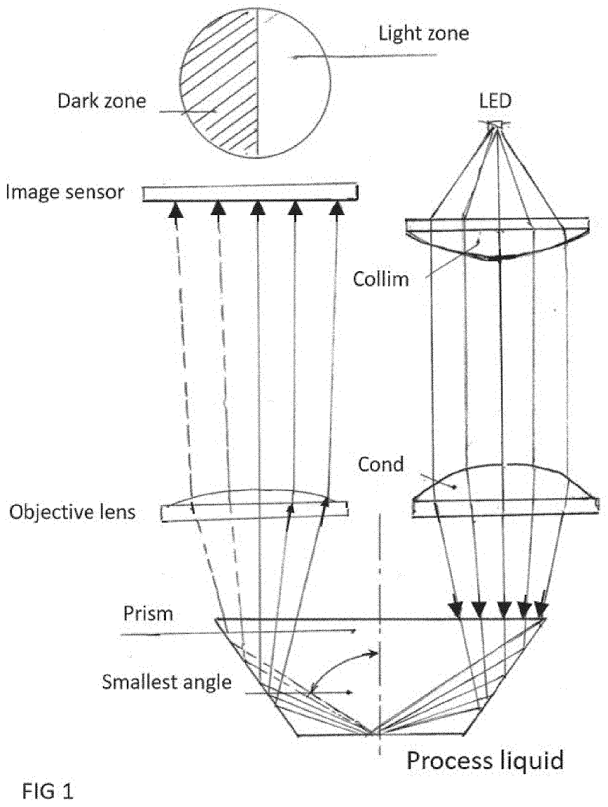

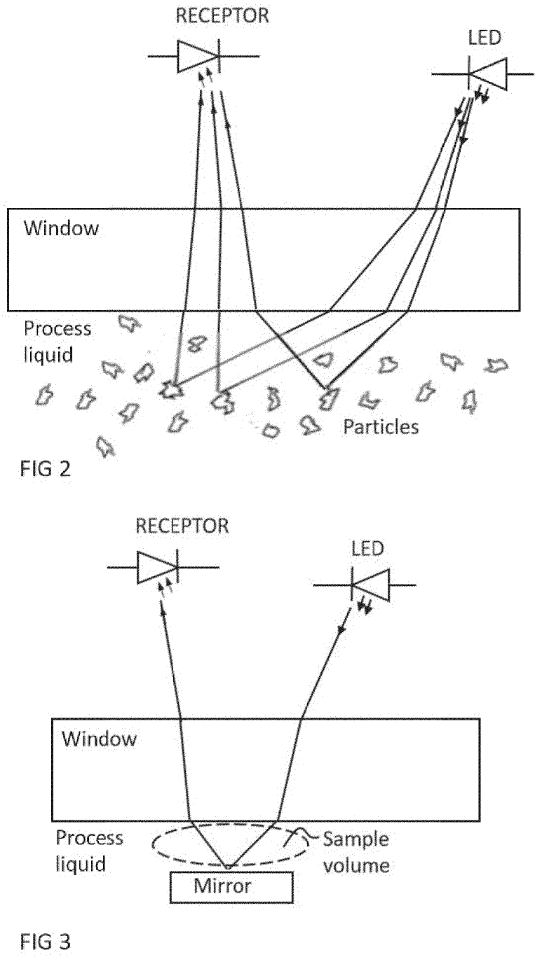

According to an embodiment of the improved optical instrument, a refractometer (FIG. 1) and any of the optical bulk measurements (FIG. 2, FIG. 3) can be combined, by using the refractometer prism as the bulk measurement window, here as embodied exemplified by one of the turbidity meter rays in FIG. 4. The “smallest angle” indicated, corresponds to the lowest concentration the refractometer can measure, typically water. If the process liquid is water, then all rays with an angle of incidence greater than the “smallest angle” is reflected. It means that all rays with angle of incidence less than the “smallest angle” penetrates water and are eligible for bulk measurement.

Both of the refractometer and the optical bulk measurements here described are well established being used in methods directed to the process liquid analyzing. According to an embodiment the refractometer prism does double duty as a bulk measurement window (FIG. 4)

Instead of direct light sources, also optical fibers can be used in embodiments to transfer the light for the turbidity and/or color measurement. Especially for small diameter probes, this is useful (FIG. 5a and FIG. 5b). In FIG. 5a such an embodiment is illustrated in which there is one single optical fiber to be used both directions to emit the light into the liquid for the turbidity measurement as well as to convey the light scattered from the particles to the imaging part of the turbidity meter.

In FIG. 5b, there is shown an example on an optional implementation, according to which the emitted light (E) and backscattered light (B) are led through the dedicated optical fibers. In FIGS. 5a and 5b show a detail at the optical instrument tip as a skilled person in the art can understand from the Figs.

The traditional color measurement applies in turn three light sources of different wavelengths. Combining the measurements yields the true color.

A light source wavelength can also be outside the visible spectrum, and measures absorption peaks. E.g., carbon dioxide CO2 can be measured because has an infrared absorption peak close to 4 μm.

According to an embodiment variant, the lighting can also facilitate measurements of fluorescence being included into the color measurement concept by the improver optical instrument as embodied.

According to an embodiment the light sources can be each turned on and off independently on each other so facilitating them being operated in arbitrary order and/or arbitrary durations to illuminate, including sequences in overlapping orders, if required in an arbitrary specific process for the liquid, the operator via the computer code can decide the illumination details, such as the duration of each light source illumination, the power, and the sequence and/or the order in respect to the other light sources corresponding operations.

The microprocessor can read the receptor according to the illumination in a synchronism, to provide the image therefrom, so that the operator has a fully control to the illumination, so that the multiple light sources, can be prevented from disturbing each other. A program will run the light sources consecutively.

The bulk properties don't disturb the refractometer's measurement of the process liquid concentration. That's used as a selling point for a refractometer: Insensitive to particles, bubbles and color of the liquid. The refractometer measures the edge of the light zone on the image sensor (FIG. 1). The light zone consists of the totally reflected rays. They don't penetrate the process liquid; hence they are oblivious of the volume properties.

The other way around is not true. What happens at the surface influences the bulk measurements. As rays pass from the prism to the process liquid, the transmission intensities and the directions can be influenced by the refractive indices of the prism and the liquid respectively. That influence is determined by Fresnel's equations. The prism refractive index is constant (save for temperature changes). But the refractive index of the liquid varies. There may be a need to compensate the optical bulk measurement for this variation. This invention has the unique capability to perform this compensation.

According to an embodiment the operations as well as the settings of the improved optical instrument in such a system can be controlled by a software code on a non-transitory computer readable media, comprising a computer executable code when run in a microprocessor to provide controller to control the optical instrument system.

According to an embodiment, such a software code can comprise instructions to microprocessor to control in a consecutive manner to turn the lights on and off of the light sources of the improved optical instrument.

According to an embodiment variant the timer to control of the illumination of the light sources can be implemented optionally by a hardware electronics-based logic to provide the sequence of the illumination as such in an optional implementation of the improved optical instrument.

1. An improved optical instrument, comprising at least one of the following within a same refractometer probe: a turbidity meter and a color meter.

2. The improved optical instrument of claim 1, comprising in the same device, the refractometer prism in a double duty as a refractometer prism and a bulk measurement window.

3. The improved optical instrument of claim 1, wherein the color meter is adapted in the color measurement to apply in turn an ensemble of light sources comprising more than one light sources of different wavelengths.

4. The improved optical instrument of claim 3, wherein each color is produced by that color's own light source, to transform the optical signal in each respective color to corresponding electrical signal to provide a combination of the color signals in the measurements to yield the true color of the process liquid.

5. The improved optical instrument according to claim 1, wherein the at least one of the light sources of the optical instrument has such a light source whose emitted light has a wavelength that is in the visible spectrum range.

6. The improved optical instrument according to claim 1, wherein at least one of the light sources of the optical instrument has such a light source whose emitted light has a wavelength that is outside the said visible spectrum range.

7. A method of measuring absorption peaks, comprising providing the optical instrument of claim 1, and applying the optical instrument to measure the absorption peaks.

8. The method of claim 7, comprising measuring absorption peak of carbon dioxide.

9. A method of compensating for refractive index variation in bulk measurements, comprising providing the optical instrument of claim 1, and applying the optical instrument to perform the compensating.

10. The improved optical instrument of claim 1, wherein the improved optical instrument comprises a light source to provide incident light in a fluorescence measurement of the process liquid.

11. The improved optical instrument of claim 8, wherein the improved optical instrument comprises a receptor acting as a detector to detect as a secondary fluorescence light, at a fluorescence light source wavelength stimulated light as a response to the incident light.

12. The improved optical instrument of claim 10, wherein the improved optical instrument comprises an optical filter to filter out such light with wavelengths that are outside a certain desired range of fluorescence measurement light wavelengths, in a wavelength range that is of said incident light and/or secondary light.

13. The improved optical instrument according to claim 1, wherein the optical instrument comprises an ensemble of light sources each with at least one light-source-dedicated wavelength to emit the light in a bulk measurement by the improved optical instrument.

14. The improved optical instrument according to claim 1, wherein said ensemble of light sources are set to lighten in a sequence controlled by a controller to control the light source illumination in a bulk measurement by the improved bulk measurement.

15. The improved optical instrument according to claim 1, comprising a probe tip diameter of ½″ or 12 mm.

16. An improved optical instrument system comprising at least one improved optical instrument according to claim 1, wherein the system has a microprocessor, to control the illumination of at least one light source in a bulk measurement, as to provide the functionality of the controller of the optical instrument system.

17. A non-transitory computer-readable medium on which is stored software code that, when executed by the microprocessor of the improved optical instrument system of claim 16, causes the microprocessor to control the optical instrument system of claim 16.

18. The non-transitory computer-readable medium of claim 17, wherein the software code causes the microprocessor to control in a consecutive manner to turn the light on and off of the light sources of the improved optical instrument.

19. The improved optical instrument according to claim 1, wherein at least one of the light sources of the optical instrument has such a light source whose emitted light has a wavelength that is outside the visible spectrum range up to a wavelength less than 10 μm.

20. The improved optical instrument according to claim 19, wherein the emitted light has a wavelength that is outside the visible spectrum range up to a wavelength less than 6 μm.
